(19) United States
(12) Patent Application Publication
(10) Pub. No.: US 2026/0097627 A1
(43) Pub. Date: Apr. 9, 2026

(54) AIR CONDITIONING SYSTEM AND VEHICLE INCLUDING THE SAME

(71) Applicants: HYUNDAI MOTOR COMPANY, Seoul (KR); Kia Corporation, Seoul (KR)

(72) Inventors: Jeawan KIM, Hwaseong-si (KR); Hochan AN, Hwaseong-si (KR); Yeon Ho KIM, Hwaseong-si (KR); Hoyoung JEONG, Hwaseong-si (KR); Man Hee PARK, Hwaseong-si (KR); Yeong Jun KIM, Hwaseong-si (KR); Jae Yeon KIM, Hwaseong-si (KR); Gwi Taek KIM, Hwaseong-si (KR)

(73) Assignees: HYUNDAI MOTOR COMPANY, Seoul (KR); Kia Corporation, Seoul (KR)

(21) Appl. No.: 19/262,787

(22) Filed: Jul. 8, 2025

(30) Foreign Application Priority Data
Oct. 8, 2024 (KR) 10-2024-0136330

(51) Int. Cl. B60H 1/32

(52) U.S. Cl. CPC B60H 1/3205

(57) ABSTRACT

An air conditioning system and a vehicle including the same, include a compressor that compresses refrigerant into a high-temperature and high-pressure gas; a condenser that condenses the refrigerant compressed by the compressor, a receiver dryer that stores liquid refrigerant; an expansion valve that expands the refrigerant condensed by the condenser; an evaporator that evaporates the refrigerant passing through the expansion valve into a low-temperature and low-pressure refrigerant; and a safety container in which the condenser, the receiver dryer, the expansion valve, and the evaporator are installed, excluding the compressor.

### CROSS-REFERENCE TO RELATED APPLICATION

The present application claims priority to and the benefit of Korean Patent Application No. 10-2024-0136330 filed in the Korean Intellectual Property Office on Oct. 8, 2024, the entire contents of which are incorporated herein by reference.

### BACKGROUND OF THE INVENTION

### Field of the Present Disclosure

The present disclosure relates to an air conditioning system and a vehicle including the same, and more particularly, to an air conditioning system and a vehicle including the same that may safely utilize an environmentally friendly refrigerant with high flammability and explosiveness.

### Description of the Related Art

Generally, an air conditioning system for a vehicle includes an air conditioning system for circulating a refrigerant to heat or cool an interior of the vehicle.

The air conditioning system, which may maintain a fresh indoor condition by maintaining an indoor temperature of a vehicle at an appropriate temperature regardless of an outdoor temperature change, is configured to cool an interior of the vehicle by heat-exchange by a condenser and an evaporator during a process in which a refrigerant discharged by driving a compressor is circulated to the compressor again by passing through the condenser, a receiver drier, an expansion valve, and the evaporator.

That is, in the air conditioning system, a high-temperature and high-pressure gaseous refrigerant compressed by the compressor is condensed through the condenser, then is evaporated by the evaporator through the receiver drier and the expansion valve to lower the indoor temperature and humidity in a summer cooling mode.

Recently, as a concern about energy efficiency and environmental pollution has gradually increased, development of an environment-friendly vehicle configured for being substantially substituted for a vehicle having an internal combustion engine has been required, and the environment-friendly vehicles are typically classified into an electric vehicle which is typically driven using a fuel cell or electricity as a power source, and a hybrid vehicle which is driven using an engine and an electric battery.

In the electric vehicle and the hybrid vehicle of the environment-friendly vehicles, a separate heater is not used, unlike an air conditioner of a general vehicle, and an air conditioner, which is applied to the environment-friendly vehicle, is typically referred to as a heat pump system.

Meanwhile, as interest in environmental regulations has grown worldwide in recent years, regulations on the use of substances that pollute the global environment are being strengthened.

Refrigerants used in air conditioning systems contain perfluorinated compounds (PFAS), which do not react with water, oil, chemicals, and heat, and maintain their original molecular structure. As a result, they are excellent in waterproofing, oil repellency, chemical resistance, and heat resistance, and are utilized in almost all industries. However, since these perfluorinated compounds are not easily decomposed, there is a problem of them accumulating in the human body and the environment.

To solve this problem, each country regulates the use of perfluorinated compounds. To this end, research is being conducted to replace perfluorinated compounds in refrigerants used in air conditioning systems with environment-friendly refrigerants.

The environment-friendly refrigerants include the advantage of being environmentally friendly because they include a very low global warming potential (GWP) and excellent cycle performance because they include a large latent heat capacity. However, since environment-friendly refrigerants are classified as highly flammable substances, when using environment-friendly refrigerants in air conditioning systems, safety design against flammability and explosion is required.

The above information included in this Background section is only for enhancement of understanding of the background of the disclosure, and therefore it may contain information that does not form the related art that is already known in this country to a person of ordinary skill in the art.

### SUMMARY OF THE INVENTION

An object to be solved attempts to provide an air conditioning system and a vehicle including the same that may safely use an environmentally friendly refrigerant with high flammability and explosiveness.

An exemplary embodiment of the present disclosure provides an air conditioning system, including: a compressor that compresses refrigerant into a gas having a temperature higher than a predetermined temperature and a pressure higher than a predetermined pressure; a condenser that is connected to the compressor and condenses the refrigerant compressed by the compressor; a receiver dryer that is connected to the condenser and stores liquid refrigerant; an expansion valve that is connected to the condenser and expands the refrigerant condensed by the condenser; an evaporator that is connected to the expansion valve and evaporates the refrigerant passing through the expansion valve into a refrigerant having a temperature lower than a predetermined temperature and a pressure lower than a predetermined pressure; and a safety container in which the condenser, the receiver dryer, the expansion valve, and the evaporator are disposed, wherein the compressor is disposed outside the safety container.

In some embodiments, the air conditioning system may further include a first shut-off valve disposed in a refrigerant line fluidly connecting the compressor and the condenser; and a second shut-off valve disposed in the refrigerant line fluidly connecting the compressor and the evaporator.

In some embodiments, the first shut-off valve may be disposed at a portion where the refrigerant line between the compressor and the condenser passes through the safety container.

In some embodiments, the second shut-off valve may be disposed at a portion where the refrigerant line between the condenser and the compressor passes through the safety container.

In some embodiments, the air conditioning system may further include a refrigerant detecting sensor which is configured to detect refrigerant leakage from the safety container.

In some embodiments, when the refrigerant leakage is detected through the refrigerant detecting sensor, the first shut-off valve and the second shut-off valve may be blocked.

In some embodiments, the refrigerant may be an R290 refrigerant.

Another embodiment provides a vehicle including: a cabin room in which a passenger boards; and an air conditioning system that cools or heats an interior of the cabin room, wherein the air conditioning system includes a compressor that compresses refrigerant into a gas having a temperature higher than a predetermined temperature and a pressure higher than a predetermined pressure; a condenser that is connected to the compressor and condenses the refrigerant compressed by the compressor into a liquid having a temperature higher than a predetermined temperature; a receiver dryer that is connected to the condenser and stores liquid refrigerant; an expansion valve that is connected to the condenser and expands the refrigerant condensed by the condenser; an evaporator that is connected to the expansion valve and evaporates the refrigerant passing through the expansion valve into a refrigerant having a temperature lower than a predetermined temperature and a pressure lower than a predetermined pressure; and a safety container in which the condenser, the receiver dryer, the expansion valve, and the evaporator are disposed, wherein the compressor is disposed outside the safety container.

In some embodiments, the air conditioning system may be provided at a rear based on a driving direction of the vehicle.

In some embodiments, the condenser and the receiver dryer of the air conditioning system may be disposed at the rear of the cabin room, adjacent to the cabin room.

In some embodiments, the air conditioning system may be provided at a front based on a driving direction of the vehicle.

In some embodiments, the condenser and the receiver dryer of the air conditioning system may be disposed at the front of the cabin room, adjacent to the cabin room.

In some embodiments, the air conditioning system may further include a first shut-off valve disposed in a refrigerant line fluidly connecting the compressor and the condenser; and a second shut-off valve disposed in the refrigerant line fluidly connecting the compressor and the evaporator.

In some embodiments, the first shut-off valve may be disposed at a portion where the refrigerant line between the compressor and the condenser passes through the safety container.

some embodiments, the second shut-off valve may be disposed at a portion where the refrigerant line between the condenser and the compressor passes through the safety container.

In some embodiments, the air conditioning system may further include a refrigerant detecting sensor which is configured to detect refrigerant leakage from the safety container.

In some embodiments, when the refrigerant leakage is detected through the refrigerant detecting sensor, the first shut-off valve and the second shut-off valve may be blocked.

In some embodiments, the refrigerant may be an R290 refrigerant.

According to the embodiments, each component of the air conditioning system except for the compressor is provided inside the safety container, ensuring the safety of an environment-friendly refrigerant with high flammability and explosiveness.

Furthermore, the effects which may be obtained or expected from the embodiments of the present disclosure will be directly or implicitly included in the detailed description of the present disclosure. That is, various effects expected from the embodiments of the present disclosure will be described in the following detailed description.

### BRIEF DESCRIPTION OF THE DRAWINGS

These drawings are for reference only in describing embodiments of the present disclosure, and therefore the technical idea of the present disclosure should not be limited to the accompanying drawings.

FIG. 1 illustrates a schematic view of an air conditioning system according to an embodiment.

FIG. 2 illustrates a schematic view of a vehicle to which an air conditioning system according to an embodiment is applied.

FIG. 3 illustrates a schematic view of a vehicle to which an air conditioning system according to another embodiment is applied.

It should be understood that the above-referenced drawings are not necessarily to scale, presenting a somewhat simplified representation of various exemplary features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

The terminology used herein is for describing particular embodiments only and is not intended to be limiting of the present disclosure. As used herein, the singular forms “a,” “an,” and “the” are intended to include the plural forms as well, unless the context clearly indicates otherwise. The terms “include” and/or “including” and “comprise” and/or “comprising” specify the presence of the mentioned characteristics, integers, steps, operations, constituent elements, and/or components when used in the present specification, but it will also be understood that this does not exclude the presence or addition of one or more of other characteristics, integers, steps, operations, constituent elements, components, and/or groups thereof. As used herein, the term “and/or” includes any one or all combinations of the associated and listed items.

The present disclosure will be described more fully hereinafter with reference to the accompanying drawings, in which embodiments of the disclosure are shown. However, as those skilled in the art would realize, the described embodiments may be modified in various different ways, all without departing from the spirit or scope of the only and present disclosure.

To clearly describe the present disclosure, parts or portions that are irrelevant to the description are omitted, and identical or similar constituent elements throughout the specification are denoted by the same reference numerals.

Furthermore, since the size and thickness of each configuration shown in the drawings are arbitrarily shown for convenience of description, the present disclosure is not necessarily limited to configurations illustrated in the drawings, and in order to clearly illustrate several parts and areas, enlarged thicknesses are shown.

The terms “module” and/or “unit, portion, or part” representing constituent element used in the following description are used only to make understanding of the specification easier, and thus, these terms do not have meanings or roles that distinguish them from each other by themselves.

In addition, in describing embodiments, when it is determined that a detailed description of the well-known art associated with the present disclosure may obscure the gist of the present disclosure, it will be omitted.

Furthermore, the accompanying drawings are provided only to allow embodiments included in the present specification to be easily understood and are not to be interpreted as limiting the spirit included in the present specification, and it is to be understood that the present disclosure includes all modifications, equivalents, and substitutions without departing from the scope and spirit of the present disclosure.

Terms including an ordinal number, such as first, second, etc., may be used to describe various elements, but the elements are not limited by the terms.

In the description below, a singular form may be intended to include a plural form as well, unless an explicit expression such as “one” or “single” is used.

These terms are only used to differentiate one constituent element from another.

Hereinafter, an air conditioning system and a vehicle including the same according to an embodiment will be described in detail with reference the accompanying drawings.

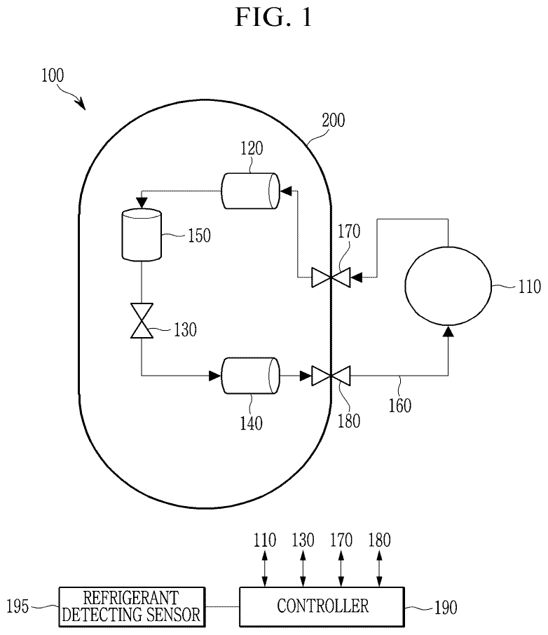

FIG. 1 illustrates a schematic view of an air conditioning system according to an embodiment.

As shown in FIG. 1, an air conditioning system 100 according to an embodiment may include a compressor 110, a condenser 120, an expansion valve 130, and an evaporator 140 disposed along a refrigerant line 160 through which a refrigerant flows.

The refrigerant flowing along the refrigerant line 160 may be environment-friendly R290 refrigerant. The R290 refrigerant is environmentally friendly because it has a very low global warming potential (GWP) of 3, but it has a very high flammability rating, making it highly flammable and explosive, so precautions may be taken.

The compressor 110 may compress a gaseous refrigerant into a high-temperature and high-pressure gas. The condenser 120 may condense the refrigerant compressed by the compressor 110 into a liquid state. The expansion valve 130 expands the refrigerant condensed by the condenser 120, so that the pressure of the refrigerant is lowered from high pressure to low pressure. The evaporator 140 absorbs heat from the outside air as the low-pressure refrigerant passing through the expansion valve 130 is vaporized, so that the liquid refrigerant is phase-changed into a gaseous refrigerant.

In other words, the heat-exchange medium (for example, refrigerant) discharged by the driving of the compressor 110 is circulated back to the compressor 110 through the condenser 120, the expansion valve 130, and the evaporator 140. In the present process, heat-exchange between the refrigerant and the indoor air of a cabin room 310 in a vehicle 300 is performed through the evaporator 140, and as a result, the air conditioning system 100 may cool the cabin room 310. That is, the air conditioning system 100 lowers the temperature and humidity of the cabin room 310 by condensing the high temperature and high pressure gaseous refrigerant compressed from the compressor 110 through the condenser 120, then passing through the expansion valve 130 and evaporating in the evaporator 140.

Meanwhile, a receiver dryer 150 may be disposed in the refrigerant line 160 between the condenser 120 and the expansion valve 130. The receiver dryer 150 may store the refrigerant condensed by the condenser 120 and remove moisture contained in the refrigerant. If necessary, the receiver dryer 150 may selectively discharge gaseous refrigerant and liquid refrigerant from among the refrigerant that has undergone heat-exchange in the heat-exchanger. The receiver dryer 150 may be provided with a desiccant therein.

The air conditioning system 100 according to the exemplary embodiment may include a safety container including the condenser 120, the receiver dryer 150, the expansion valve 130, and the evaporator 140, excluding the compressor 110.

The reason why only the remaining condenser 120, receiver dryer 150, expansion valve 130, and evaporator 140 of the air conditioning system 100 excluding the compressor 110 are disposed inside the safety container is as follows.

To dispose the compressor 110 inside the safety container, a separate wiring structure for supplying power to the compressor 110 is required, but it is difficult to connect a high-voltage wiring inside the safety container. In other words, when a wiring structure for supplying a high voltage to the compressor 110 is provided in the safety container, a leak may occur in the safety container. In addition, it may be difficult to connect the high voltage wiring (cable) to the compressor 110 through the safety container.

Next, to dispose the compressor 110 inside the safety container, it is necessary to design the safety container to insulate the vibration of the safety container. When the compressor 110 is provided inside the safety container, the design complexity of the safety container may increase and the size of the safety container may increase. Additionally, when the compressor 110 is provided inside the safety container, the durability of the safety container may deteriorate due to the vibration of the compressor 110. Additionally, when the compressor 110 is provided inside the safety container, the noise generated due to the operation of the compressor 110 is reflected inside the safety container and amplified, and the amplified noise is released to the outside thereof.

Furthermore, when the compressor 110 is sealed inside the safety container, inspection, maintenance, and repair of the compressor 110 may be difficult.

Furthermore, when the compressor 110 among the components of the air conditioning system 100 is disposed inside the safety container, the overall size of the safety container increases, which increases the inefficiency of space utilization in the vehicle.

Finally, when the compressor 110 is disposed inside the safety container, it is difficult to inject the refrigerant into the compressor 110. To solve these problems, the compressor 110 is disposed outside the safety container.

To prevent refrigerant from leaking out of the condenser 120, receiver dryer 150, expansion valve 130, and evaporator 140 of the air conditioning system 100 to the outside of the safety container, the safety container may be a pressure-resistant designed container.

The safety container of the air conditioning system 100 according to the exemplary embodiment may include a first shut-off valve 170 provided in the refrigerant line 160 fluidly connecting the compressor 110 and the condenser 120, a second shut-off valve 180 provided in the refrigerant line 160 fluidly connecting the compressor 110 and the evaporator 140, a refrigerant detecting sensor 195 for detecting whether refrigerant is leaking from the safety container, and a controller 190 for controlling the operation of the first shut-off valve 170 and the second shut-off valve 180.

The first shut-off valve 170 may be disposed at a portion where the refrigerant line 160 between the compressor 110 and the condenser 120 passes through the safety container. Furthermore, the second shut-off valve 180 may be disposed at a portion where the refrigerant line 160 between the evaporator 140 and the compressor 110 passes through the safety container.

When the controller 190 determines that the refrigerant has leaked out by the refrigerant detecting sensor 195, the controller 190 may block the first shut-off valve 170 and the second shut-off valve 180.

To the present end, the controller 190 may be implemented with one or more processors that operate according to a set program, and the memory of the controller 190 stores program instructions programmed to perform each step of the control method of the air conditioning system 100 of the present disclosure through one or more processors.

Next, a state in which the air conditioning system according to the exemplary embodiment of the present disclosure is provided in the vehicle will be described in detail with reference to the accompanying drawings.

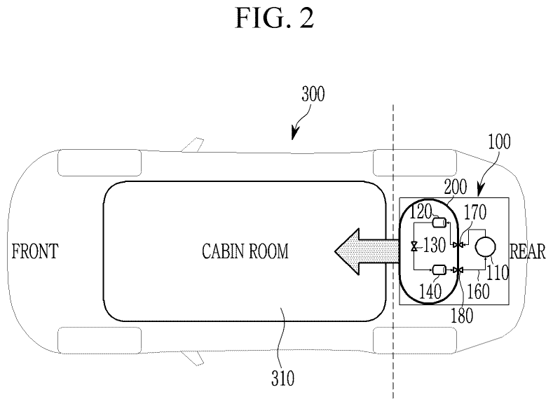

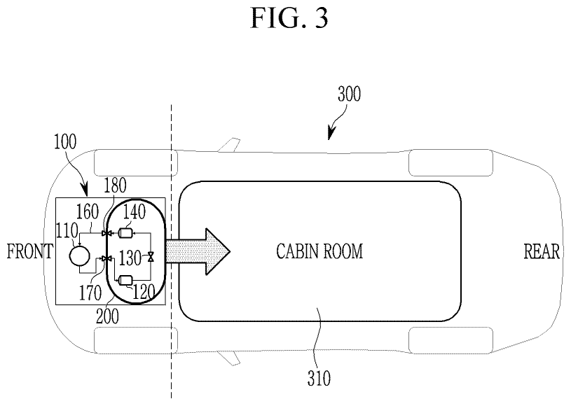

FIG. 2 illustrates a schematic view of a vehicle to which an air conditioning system according to an exemplary embodiment of the present disclosure is applied. FIG. 3 illustrates a schematic view of a vehicle to which an air conditioning system according to another embodiment is applied.

Referring to FIG. 2, an air conditioning system according to an exemplary embodiment of the present disclosure may be provided inside the vehicle 300. For example, the air conditioning system 100 may be disposed at the rear of the cabin room 310, in which passengers, including the driver, are seated.

In the present disclosure, a direction in which the vehicle 300 travels based on the driving direction of the vehicle 300 may be referred to as a front, and a direction opposite to the driving direction may be referred to as a rear.

When the air conditioning system is disposed at the rear of the cabin room 310, the condenser 120 and the receiver dryer 150 of the air conditioning system 100 may be disposed to face the cabin room 310. In other words, the condenser 120 and the receiver dryer 150 of the air conditioning system 100 may be disposed at the rear of the cabin room 310 adjacent to the cabin room 310.

Accordingly, since the condenser 120 and the receiver dryer 150 of the air conditioning system 100 are disposed adjacent to the cabin room 310 and at the rear of the cabin room 310, even if an accident such as a frontal collision occurs while the vehicle 300 is driving, damage to the condenser 120 and receiver dryer 150 in which a large amount of liquid-state refrigerant is stored may be minimized.

That is, even if a frontal collision accident of the vehicle 300 occurs, since the impact caused by the collision is absorbed by the cabin room 310, damage to the condenser 120 and receiver dryer 150 storing the environment-friendly refrigerant may be minimized. Accordingly, the safety of the air conditioning system 100 to which an environment-friendly refrigerant is applied may be ensured.

Referring to FIG. 3, an air conditioning system according to another embodiment may be provided inside the vehicle 300. For example, the air conditioning system 100 may be disposed at the front of the cabin room 310, in which passengers, including the driver, are seated.

When the air conditioning system is disposed at the front of the cabin room 310, the condenser 120 and the receiver dryer 150 of the air conditioning system 100 may be disposed to face the cabin room 310. In other words, the condenser 120 and the receiver dryer 150 of the air conditioning system 100 may be disposed at the front of the cabin room 310 adjacent to the cabin room 310.

Accordingly, since the condenser 120 and the receiver dryer 150 of the air conditioning system 100 are disposed adjacent to the cabin room 310 and at the front of the cabin room 310, even if an accident such as a frontal collision occurs while the vehicle 300 is driving, damage to the condenser 120 and receiver dryer 150 in which a large amount of liquid-state refrigerant is stored may be minimized.

According to the air conditioning system and the vehicle including the same of the exemplary embodiment of the present disclosure, even if an environment-friendly refrigerant such as R290 refrigerant with high flammability and explosiveness is applied to the air conditioning system 100, components such as the condenser 120 and the receiver dryer 150 in which a large amount of liquid refrigerant is stored are provided inside the safety container, securing the safety of the vehicle 300 provided with the air conditioning system 100 to which the environment-friendly refrigerant is applied.

While the present disclosure has been described in connection with what is presently considered to be practical embodiments, it is to be understood that the disclosure is not limited to the disclosed exemplary embodiments of the present disclosure, but, on the contrary, is intended to cover various modifications and equivalent arrangements included within the spirit and scope of the appended claims.

### DESCRIPTION OF SYMBOLS

100: air conditioning system
110: compressor
120: condenser
130: expansion valve
140: evaporator
150: receiver dryer
160: refrigerant line
170: first shut-off valve
180: second shut-off valve
190: controller
195: refrigerant detecting sensor
200: safety container
300: vehicle
310: cabin room

What is claimed is:

1. An air conditioning system, comprising:
a compressor that compresses refrigerant into a gas having a temperature higher than a predetermined temperature and a pressure higher than a predetermined pressure;
a condenser that is connected to the compressor and condenses the refrigerant compressed by the compressor;
a receiver dryer that is connected to the condenser and stores liquid refrigerant;
an expansion valve that is connected to the condenser and expands the refrigerant condensed by the condenser;
an evaporator that is connected to the expansion valve and evaporates the refrigerant passing through the expansion valve into a refrigerant having a temperature lower than a predetermined temperature and a pressure lower than a predetermined pressure; and
a safety container in which the condenser, the receiver dryer, the expansion valve, and the evaporator are disposed, wherein the compressor is disposed outside the safety container.

2. The air conditioning system of claim 1, further comprising:
a first shut-off valve disposed in a refrigerant line fluidly connecting the compressor and the condenser; and
a second shut-off valve disposed in the refrigerant line fluidly connecting the compressor and the evaporator.

3. The air conditioning system of claim 2, wherein the first shut-off valve is disposed at a portion where the refrigerant line between the compressor and the condenser passes through the safety container.

4. The air conditioning system of claim 2, wherein the second shut-off valve is disposed at a portion where the refrigerant line between the condenser and the compressor passes through the safety container.

5. The air conditioning system of claim 2, further comprising a refrigerant detecting sensor which is configured to detect refrigerant leakage from the safety container.

6. The air conditioning system of claim 5, wherein, based on that the refrigerant leakage is detected through the refrigerant detecting sensor, the first shut-off valve and the second shut-off valve are blocked.

7. The air conditioning system of claim 6, further comprising a controller, wherein based on that the controller concludes that the refrigerant has leaked out by the refrigerant detecting sensor, the controller controls the first shut-off valve and the second shut-off valve to be blocked.

8. The air conditioning system of claim 1, wherein the refrigerant is an R290 refrigerant.

9. A vehicle comprising:
a cabin room in which a passenger boards; and
an air conditioning system that cools or heats an interior of the cabin room,
wherein the air conditioning system includes:
a compressor that compresses refrigerant into a gas having a temperature higher than a predetermined temperature and a pressure higher than a predetermined pressure;
a condenser that is connected to the compressor and condenses the refrigerant compressed by the compressor into a liquid having a temperature higher than a predetermined temperature;
a receiver dryer that is connected to the condenser and stores the liquid refrigerant;
an expansion valve that is connected to the condenser and expands the refrigerant condensed by the condenser;
an evaporator that is connected to the expansion valve and evaporates the refrigerant passing through the expansion valve into a refrigerant having a temperature lower than a predetermined temperature and a pressure lower than a predetermined pressure; and
a safety container in which the condenser, the receiver dryer, the expansion valve, and the evaporator are disposed, wherein the compressor is disposed outside the safety container.

10. The vehicle of claim 9, wherein the air conditioning system is disposed at a rear based on a driving direction of the vehicle.

11. The vehicle of claim 10, wherein the condenser and the receiver dryer of the air conditioning system are disposed at the rear of the cabin room, adjacent to the cabin room.

12. The vehicle of claim 9, wherein the air conditioning system is disposed at a front based on a driving direction of the vehicle.

13. The vehicle of claim 12, wherein the condenser and the receiver dryer of the air conditioning system are disposed at the front of the cabin room, adjacent to the cabin room.

14. The vehicle of claim 9, further comprising:
a first shut-off valve disposed in a refrigerant line fluidly connecting the compressor and the condenser; and
a second shut-off valve disposed in the refrigerant line fluidly connecting the compressor and the evaporator.

15. The vehicle of claim 14, wherein the first shut-off valve is disposed at a portion where the refrigerant line between the compressor and the condenser passes through the safety container.

16. The vehicle of claim 14, wherein the second shut-off valve is disposed at a portion where the refrigerant line between the condenser and the compressor passes through the safety container.

17. The vehicle of claim 14, further comprising a refrigerant detecting sensor which is configured to detect refrigerant leakage from the safety container.

18. The vehicle of claim 17, wherein based on that the refrigerant leakage is detected through the refrigerant detecting sensor, the first shut-off valve and the second shut-off valve are blocked.

19. The vehicle of claim 18, further comprising a controller, wherein based on that the controller concludes that the refrigerant has leaked out by the refrigerant detecting sensor, the controller controls the first shut-off valve and the second shut-off valve to be blocked.

20. The vehicle of claim 9, wherein the refrigerant is an R290 refrigerant.
